(19) United States
(12) Patent Application Publication
(10) Pub. No.: US 2011/0265486 A1
(43) Pub. Date: Nov. 3, 2011

(54) COMBUSTION SYSTEM WITH VARIABLE PRESSURE DIFFERENTIAL FOR ADDITIONAL TURNDOWN CAPABILITY OF A GAS TURINE ENGINE

(76) Inventor: Adam D. Plant, Orlando, FL (US)

(21) Appl. No.: 12/769,934

(22) Filed: Apr. 29, 2010

(51) Int. Cl. F02C 7/057

(52) U.S. Cl. 60/773; 60/39.23

(57) ABSTRACT

A turbine engine assembly for a generator including a turbine engine having a compressor section, a combustor section and a turbine section, and the turbine engine having a base load. The combustor section includes a combustor and a combustor shell. A flow control device is located in a flow path between the combustor shell and an inlet to the combustor. The flow control device effects an increase in a pressure drop of shell air flowing from the combustor shell to the combustor. A controller is provided for operating the flow control device to change a pressure drop across the flow control device, wherein an increase in the pressure drop across the flow control device results in a corresponding reduction in mass flow through the combustor for effecting a reduction in power output from the turbine engine during a reduction in an operating load to less than the base load.

### FIELD OF THE INVENTION

The present invention relates generally to gas turbine engines and, more particularly, to providing additional turndown capability during part load operation of a gas turbine engine for reduction of CO emissions.

### BACKGROUND OF THE INVENTION

Gas turbine power plant operators are often faced with an economic dilemma of whether or not to operate their plants during low power demand times. By operating continuously, the plant will be available to quickly produce base load power when the power demand becomes high. The plant maintenance cost will also be reduced with fewer plant starts and stops. However, operation during these low power demand times often results in negative profit margins, or losses, for the plant operator because the low cost of power does not offset the cost of fuel.

The logical solution for the plants that choose to operate continuously is to minimize the losses by minimizing fuel consumption during operation at minimum power demand. Industrial gas turbine engines are designed to operate at a constant design turbine inlet temperature under any ambient air temperature (i.e., the compressor inlet temperature). This design turbine inlet temperature allows the engine to produce maximum possible power, known as base load. Any reduction from the maximum possible base load power, such during a plant turn down, is referred to as part load operation. That is, part load entails all engine operation from 0% to 99.9% of base load power. However, operation of the plant is restricted by its exhaust gas emissions permit. Since emissions such as nitrous oxides (NOₓ) and carbon monoxide (CO) typically increase on a volumetric basis as the gas turbine power decreases, this limits how much the plant can turn down, or reduce power, during the low power demand times.

In particular, part load operation may result in the production of high levels of carbon monoxide (CO) during combustion. One known method for reducing part load CO emissions is to bring the combustor exit temperature or the turbine inlet temperature near that of the base load design temperature. It should be noted that, for purposes of this disclosure, the terms combustor exit temperature and turbine inlet temperature are used interchangeably. In actuality, there can be from about 30 to about 80 degrees Fahrenheit difference between these two temperatures due to, among other things, cooling and leakage effects occurring at the transition/turbine junction. However, with respect to aspects of the present invention, this temperature difference is insubstantial.

To bring the combustor exit temperature closer to the base load design temperature, the mass flow of air through a turbine engine can be restricted by closing compressor inlet guide vanes (IGV), which act as a throttle at the inlet of a compressor for the gas turbine engine. When the IGVs are closed, the trailing edges of each of the vanes rotate closer to the surface of an adjacent vane, thereby effectively reducing the available throat area. Reducing the throat area reduces the flow of air which the first row of rotating blades can draw into the compressor. Lower flow to the compressor leads to a lower compressor pressure ratio being established in the turbine section of the engine. Consequently, the compressor exit temperature decreases because the compressor does not input as much energy into the incoming air. Also, the mass flow of air through the turbine decreases, and the combustor exit temperature increases.

While controlling emissions during plant turn down is effectively controlled by closing the IGVs, this has limited capability. Constant speed compressors, such as those used for industrial gas turbines, have limitations on the amount that the mass air flow into the compressor may be reduced using the IGVs before running into structural and/or aerodynamic issues. Further, CO emissions increase rapidly as gas turbine engine load is reduced below approximately 60%. Once the IGVs have been closed to their limit, and the engine's exhaust temperature limit has been reached, then power typically may be reduced only by decreasing turbine inlet temperature. Turbine inlet temperature reduction corresponds to a decrease in the combustion system's primary zone temperature (T_PZ), resulting in CO and unburned hydrocarbons (UHC) being produced due to quenching of the combustion reactions in the turbine hot gas path. To prevent CO from increasing as engine load decreases, the T_PZ must be maintained at a high level.

### SUMMARY OF THE INVENTION

In accordance with an aspect of the invention, a turbine engine assembly for a generator is provided. The assembly comprises a turbine engine having a compressor section, a combustor section and a turbine section, the combustor section having a primary zone temperature (T_PZ) and the turbine engine having a base load. The combustor section includes a combustor and a combustor shell, the combustor shell receiving air from an exit of the compressor section. A variable flow restrictor is located in a flow path between the combustor shell and an inlet to the combustor. The variable flow restrictor effects an increase in a pressure drop of shell air flowing from the combustor shell to the combustor. A controller is provided for operating the variable flow restrictor to increase a pressure drop across the variable flow restrictor when an operating load is less than the base load, wherein a flow of shell air passing from the combustor shell to the combustor is decreased thereby reducing power output from the turbine engine while maintaining the T_PZ above a T_PZ lower limit.

In accordance with another aspect of the invention, a turbine engine assembly for a generator is provided. The assembly comprises a turbine engine having a compressor section, a combustor section and a turbine section, and the turbine engine having a base load. The combustor section includes a combustor and a combustor shell, the combustor shell receiving air from an exit of the compressor section. A flow control device is located in a flow path between the combustor shell and an inlet to the combustor. The flow control device effects an increase in a pressure drop of shell air flowing from the combustor shell to the combustor. A controller is provided for operating the flow control device to change a pressure drop across the flow control device, wherein an increase in the pressure drop across the flow control device results in a corresponding reduction in mass flow through the combustor for effecting a reduction in power output from the turbine engine during a reduction in an operating load to less than the base load.

In accordance with a further aspect of the invention, a method of operating a turbine engine assembly is provided comprising: sensing a load on a turbine engine for a reduced operating load; and increasing a pressure drop between a supply of shell air provided in a combustor shell and an inlet to a combustor receiving the shell air for combustion to reduce a mass flow rate of hot gases from the combustor to a turbine section of the turbine engine while maintaining a primary zone temperature (T_PZ) of the combustor above a T_PZ lower limit.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a cross-sectional view of a turbine engine assembly illustrating an exemplary embodiment of the invention;

FIG. 2 is a schematic diagram of a turbine engine assembly corresponding to FIG. 1;

FIG. 3A is an enlarged view of a portion of a combustor section including a diagrammatically illustrated flow control device in accordance with the embodiment illustrated in FIG. 1;

FIG. 3B in an enlarged view of a portion of a combustor section including a diagrammatically illustrated flow control device in accordance with a further embodiment illustrating the invention; and

FIG. 4 is a graphical illustration of CO vs T_PZ.

### DETAILED DESCRIPTION OF THE INVENTION

In the following detailed description of the preferred embodiment, reference is made to the accompanying drawings that form a part hereof, and in which is shown by way of illustration, and not by way of limitation, a specific preferred embodiment in which the invention may be practiced. It is to be understood that other embodiments may be utilized and that changes may be made without departing from the spirit and scope of the present invention.

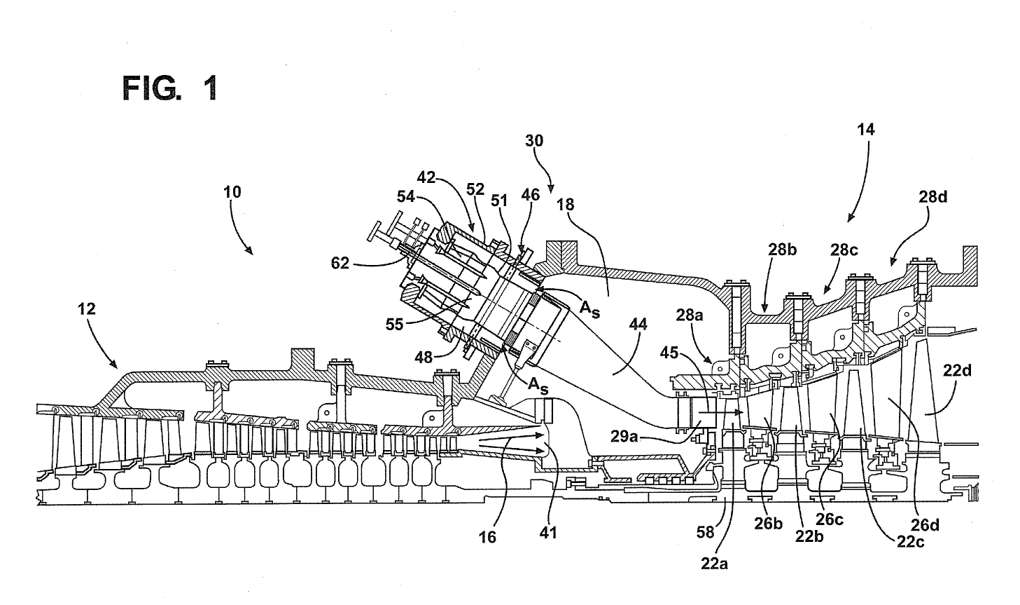

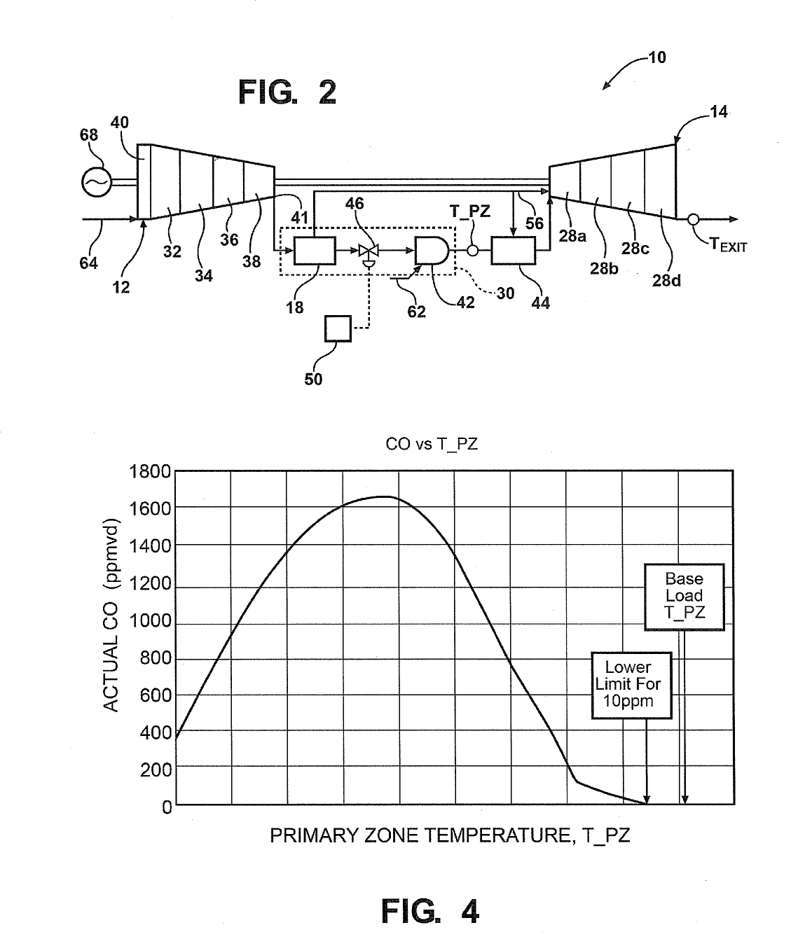

Referring initially to FIGS. 1 and 2, embodiments of the invention are directed to a turbine engine assembly 10 having a compressor section 12, a combustor section 30, and a turbine section 14. As is known in the art, the compressor section 12 can have one or more stages such as front stages 32, forward stages 34, middle stages 36, and rear stages 38 (FIG. 2). Also, the compressor section 12 can have inlet guide vanes (IGVs) 40 which can be opened and closed or otherwise adjusted to control the mass flow of air into the compressor section 12. It should be understood that the compressor section 12 of the turbine engine assembly 10 can have other vane assemblies and other assemblies that provide for flow control, including variable stator vanes.

The combustor section 30 includes a combustor shell 18 (FIG. 1) for receiving compressor exit air 16 (also known as combustor shell air) passing from a compressor exit 41, and a combustor 42 for receiving and mixing fuel with combustor shell air and igniting the air/fuel mixture to produce hot working gases for producing power in the turbine section 14. It may be noted that although the combustor section 30 is shown as including a single combustor 42, the combustor section 30 may comprise a plurality of combustors 42, as is typical in most turbine engines. A transition section or structure 44 can be provided for directing the hot working gas from the combustor 42 to a turbine section inlet at a first stage 28a of the turbine section 14 for passing through a hot gas path 45. The turbine section 14 comprises a plurality of stages including the first stage 28a, a second stage 28b, a third stage 28c, and a fourth stage 28d.

Referring to FIG. 1, the combustor section 30 further includes a flow control device 46 located in an annular area 48 between a flow sleeve 51 of the combustor 42 and an outer housing or portal wall 52. The flow control device 46 comprises a variable flow restrictor that may be controlled by a controller 50 (FIG. 2) to vary a flow area through the annular area 48 whereby a pressure drop of shell air Aₛ flowing from the combustor shell 18 to an inlet 54 of a combustion zone 55 defined inside the flow sleeve 51 may be varied. That is, an opening for shell air Aₛ passing through the flow control device 46 may be restricted or decreased to increase a pressure drop across the flow control device 46 and reduce the mass flow of air into the combustion zone 55, with a corresponding reduction in fuel flow, during a reduced load operation. The controller 50 for controlling the flow control device 46 may be any suitable controller, such as a programmable logic controller, a computer or the like, and can be a programmed function of the existing control system of the turbine engine assembly 10 or a separate controller as shown.

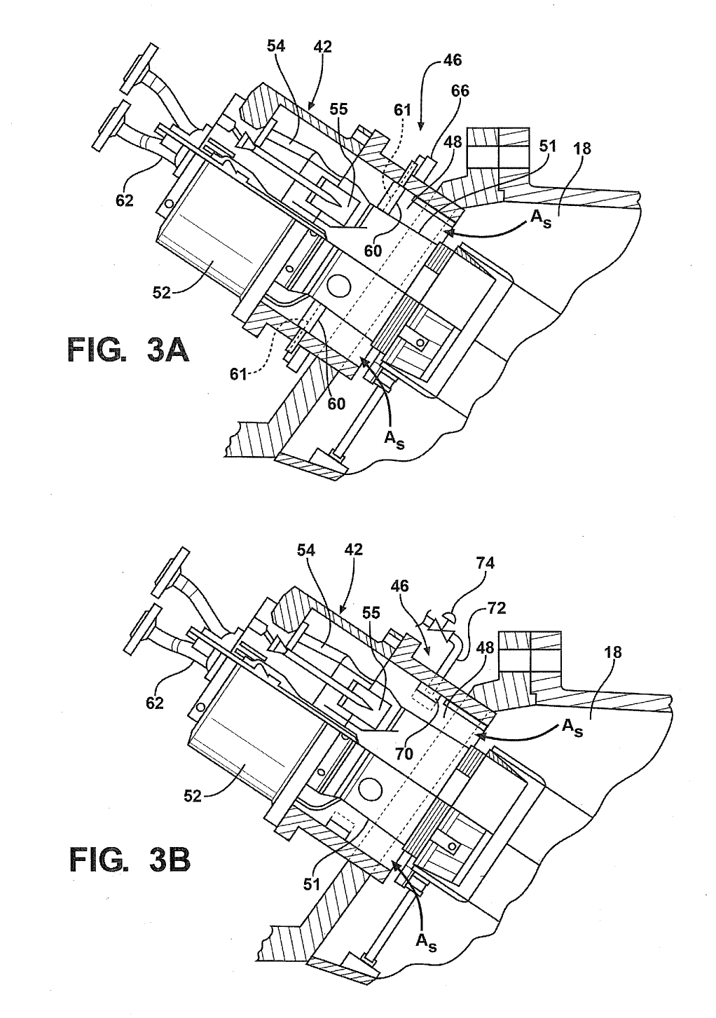

The flow control device 46 may comprise any mechanism that implements a restriction or blockage on air entering the combustor 42 for passage to the combustion zone 55. As illustrated diagrammatically in FIGS. 1 and 3A, the flow control device 46 may comprise a plurality of flaps or vanes 60 supported between the flow sleeve 51 and the portal wall 52 that may be rotated about a longitudinal axis 61 of the vane 60 to restrict air flow. The vanes 60 may be actuated by an actuator mechanism 66. For example, an actuator mechanism such as a known mechanism for actuating inlet guide vanes may be used.

Referring to FIG. 3B, an alternative embodiment of the flow control device is illustrated and may comprise an industrial high temperature inflatable bladder 70 to partially block the annular area 48 when inflated. In particular, the bladder 70 may comprise an annular, pneumatically actuated bladder provided with a connection to an air source via an air line 72, with a valve 74 actuated by the controller 50 to control the flow of air to the bladder 70. In the diagrammatic illustration of FIG. 3B, a non-restricting position of the bladder 70 is depicted in solid lines, and an actuated restricting position of the bladder 70 is depicted by dotted lines.

Other embodiments of the flow control device 46 may be implemented, depending on the particular design of the engine 10, and it should be understood that the present invention is not limited to a particular form of flow control device 46, as described herein.

A portion of the compressor exit air is provided as cooling air to turbine components, which air bypasses the combustor 42, as represented by line 56 in FIG. 2, and may be provided as cooling air to stationary components of the first stage 28a of the turbine section 14, e.g., to first row vanes 29a (FIG. 1), and to the rotor 58, as well as to the transition section 44. A portion of the rotor cooling air supplied by the flow of cooling air 56 may also be provided as cooling air to blades 22a, 22b, 22c, 22d mounted for rotation with the rotor 58. The flow of cooling air represented by line 56 may also include a heat exchanger (not shown) for cooling the air prior to passing to the components of the first stage 28a, the rotor 58 and blades 22a-d.

In the combustor section 30, air is mixed with fuel, such as may be provided through one or more fuel lines 62, and combusted to produce hot, high pressure gas and reaction products including unburned hydrocarbons (UHC) and CO. It is desirable to keep CO emissions low, preferably less than 10 ppmvd at 15% O₂. As the load on the turbine engine assembly 10 is reduced, the fuel supply to the combustors is reduced. The IGVs 40 can be closed to a limit position as the fuel supply is reduced to limit the mass flow of air into the combustor section 30. Further reductions in power typically would require a reduction in the T_PZ, which would result in increased UHC and CO production (FIG. 4) due to the quenching of the combustion reactions in the turbine hot gas path as the air/fuel ratio increases. In typical turbine operation, CO can usually only be maintained at a low level (less than about 10 ppmvd at 15% O₂) above about a 60% load.

During low load operation and turndown of the turbine engine assembly 10, a CO reduction process may be implemented, including operating the flow control device 46 to restrict the flow of shell air Aₛ to the combustion zone 55 of the combustor 42. In particular, the flow control device 46 may at least partially close or restrict the air passage through the annular area 48, increasing a pressure drop between the air in the combustor shell 18 and the air passing into the combustion zone 55 of the combustor 42. The restriction of airflow to the combustion zone 55 coincides with a reduction in the flow rate of fuel to the combustor 42 such that the air/fuel ratio is not substantially increased during low load operation and the T_PZ is maintained above a lower limit to thereby maintain the CO production at a low level, i.e., less than about 10 ppmvd at 15% O₂.

The increased pressure drop in the combustor section 30 between the combustor shell 18 and the inlet 54 to the combustor 42, resulting from the additional restriction provided by the flow control device 46 during a turndown operation, further operates to increase the shell air pressure within the combustor shell 18. As a result of the increased shell air pressure, additional work is required from the compressor section 12 to compress the air provided to the compressor exit 41 and discharged into the combustor shell 18. Accordingly, the output power to the generator 68 is further reduced during low load operation by an amount that the restriction provided by the flow control device 46 increases the load on the compressor section 12.

As noted above, a portion of the compressor exit air is provided as cooling air to stationary vanes 29a in the first stage 28a of the turbine section 14 and to the rotor 58 and associated rows of blades 22a-d, and to the transition section 44. As a result of the increased pressure of the shell air as the flow control device 46 reduces the airflow Aₛ to the combustor 42, the cooling airflow is increased to stationary vanes 29a in the first stage 28a, the rotor 58 and to the transition 44, providing additional convective cooling to these components. The additional cooling, i.e., over-cooling, provided by the increased air pressure to the turbine components is further beneficial to the present low load operation of the turbine engine 10 in that, since the T_PZ is maintained at a high temperature with the reduced flow of hot gases through the turbine section 14, the additional cooling protects the components in the hot gas path 45 to improve part life and reduce fallout.

Further, as the flow of cooling air to the components in the hot gas path 45 increases during turndown, additional cool air is discharged into the hot gas path 45 after passing through and performing convective cooling in the components. That is, additional cool air may be discharged at different locations along the hot gas path including at the transition section 44, at the stationary vanes of the first stage 28a of the turbine section 14 and at one or more stages of the blades 22a-d within the turbine section 14. The additional cool air mixes with the hot gases, providing additional quenching of the hot gases. Hence, the work performed by the hot gases is reduced, thereby further reducing the power output to the generator 68 and additionally reducing the hot gas temperature that the components are exposed to, and reducing the exhaust gas exit temperature T_{EXIT}, during low load operation.

In accordance with a particular example of the invention, in a turbine engine 10 incorporating the flow control device 46, where an unrestricted pressure drop through the combustor 42, i.e., between the combustor shell 18 and the inlet 54 to the combustion zone 55, is about 4%, the flow control device 46 may increase the pressure drop to 14%, corresponding to about a four-fold pressure drop from the unrestricted flow through the combustor 42. Further, the increased pressure in the combustor shell 18 resulting from the restricted flow to the combustor 42 may provide about a 30% increase in the cooling air flow to the transition section 44 and the first row of turbine vanes 29a, and about an 8% increase in cooling air flow to the rotor 58.

As a result of implementing the flow control device 46 to provide the controlled pressure drop through the combustor section 30, it is believed that the power output at low load operation may be reduced 15% below that available when relying solely on the closure of the IGVs 40, corresponding to a 7% reduction relative to baseload power output. In addition, the fuel consumption may be reduced 8% below that available when relying solely on the closure of the IGVs 40 at low load operation, corresponding to a 5% reduction relative to fuel consumption at baseload operation.

The flow control device 46 may be controlled by the controller 50 to progressively close, decreasing the flow rate of shell air Aₛ to the combustor 42 as the operating load is decreased, and thereby reducing power delivered to the generator 68 (FIGS. 2 and 3) while maintaining the T_PZ above a T_PZ lower limit. For example, the IGVs 40 may close initially as the load decreases, until about 60% load is reached, where the IGVs 40 are at a limit closed position. The flow control device 46 may then close to decrease the flow of shell air Aₛ to the combustor inlet 54, i.e., an inlet to the combustion zone 55, to further implement a reduction in power delivered to the generator 68 during low load operation. As noted previously, the present example is merely exemplary, and other modes of controlling the low load operation of the turbine engine assembly 10 may be implemented without departing from the spirit and scope of the invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A turbine engine assembly for a generator, the assembly comprising:
a turbine engine having a compressor section, a combustor section and a turbine section, the combustor section having a primary zone temperature (T_PZ) and the turbine engine having a base load;
the combustor section including a combustor and a combustor shell, the combustor shell receiving air from an exit of the compressor section;
a variable flow restrictor located in a flow path between the combustor shell and an inlet to the combustor, the variable flow restrictor effecting an increase in a pressure drop of shell air flowing from the combustor shell to the combustor; and
a controller for operating the variable flow restrictor to increase a pressure drop across the variable flow restrictor when an operating load is less than the base load, wherein a flow of shell air passing from the combustor shell to the combustor is decreased thereby reducing power output from the turbine engine while maintaining the T_PZ above a T_PZ lower limit.

2. The turbine engine assembly of claim 1, wherein operating the variable flow restrictor to increase the pressure drop across the variable flow restrictor results in an increase in compressor load to further effect the reduction in power output from the turbine engine.

3. The turbine engine assembly of claim 1, wherein operating the variable flow restrictor to increase the pressure drop across the variable flow restrictor results in less mass flow from the combustor section to the turbine section to further effect the reduction in power output from the turbine engine.

4. The turbine engine assembly of claim 1, wherein operating the variable flow restrictor to increase the pressure drop across the variable flow restrictor results in an increased flow of cooling air from the combustor shell to the turbine section to further effect the reduction in power output from the turbine engine.

5. The turbine engine assembly of claim 4, wherein the increased cooling air flow to the turbine section comprises an increase in cooling air flow to first stage vanes of the turbine section and to a transition member between the combustor and the first stage vanes wherein the increased cooling air provides increased quenching to hot gases flowing from the combustor to the turbine section.

6. The turbine engine assembly of claim 4, wherein the increased cooling air flow to the turbine section comprises an increase in cooling air flow to a rotor and associated blades of the turbine section, and wherein the increased cooling air provides increased quenching to hot gases flowing through the turbine section.

7. The turbine engine assembly of claim 1, further including inlet guide vanes at an inlet to the compressor section, wherein the variable flow restrictor provides a turndown of the operating load in addition to a turndown provided by the inlet guide vanes.

8. The turbine engine assembly of claim 7, wherein the variable flow restrictor effects a reduction of mass flow through the combustor to further effect the reduction in power output from the turbine engine.

9. The turbine engine assembly of claim 1, wherein the combustor section includes a housing surrounding a flow sleeve of the combustor to define an annular flow area therebetween, and the variable flow restrictor is located in the annular flow area.

10. The turbine engine assembly of claim 1, wherein the T_PZ lower limit is selected so as to maintain CO production at less than about 10 ppmvd at 15% O₂.

11. A turbine engine assembly for a generator, the assembly comprising:
a turbine engine having a compressor section, a combustor section and a turbine section, and the turbine engine having a base load;
the combustor section including a combustor and a combustor shell, the combustor shell receiving air from an exit of the compressor section;
a flow control device located in a flow path between the combustor shell and an inlet to the combustor, the flow control device effecting an increase in a pressure drop of shell air flowing from the combustor shell to the combustor; and
a controller for operating the flow control device to change a pressure drop across the flow control device, wherein an increase in the pressure drop across the flow control device results in a corresponding reduction in mass flow through the combustor for effecting a reduction in power output from the turbine engine during a reduction in an operating load to less than the base load.

12. The turbine engine assembly of claim 11, wherein the increase in pressure drop across the flow control device results in an increased load on the compressor section to further effect a reduction in power output from the turbine engine.

13. The turbine engine assembly of claim 12, wherein the increase in pressure drop across the flow control device results in an increased flow of cooling air from the combustor shell to a hot gas flow directed through the turbine section to increase a quenching of the hot gas temperature and further effect a reduction in power output from the turbine engine.

14. The turbine engine assembly of claim 11, wherein the combustor has a primary zone temperature (T_PZ), and wherein the flow of shell air passing from the combustor shell to the combustor is decreased in combination with a reduction in fuel flow to the combustor, thereby reducing the power output from the turbine engine while maintaining the T_PZ above a T_PZ lower limit.

15. The turbine engine assembly of claim 11, wherein the combustor section includes a housing surrounding a flow sleeve of the combustor and defining an annular flow area therebetween, and the variable flow restrictor is located in the annular flow area.

16. A method of operating a turbine engine assembly comprising:
sensing a load on a turbine engine for a reduced operating load; and
increasing a pressure drop between a supply of shell air provided in a combustor shell and an inlet to a combustor receiving the shell air for combustion to reduce a mass flow rate of hot gases from the combustor to a turbine section of the turbine engine while maintaining a primary zone temperature (T_PZ) of the combustor above a T_PZ lower limit.

17. The method of claim 16, wherein the increase in pressure drop between the combustor shell and the combustor corresponds to an increase in a load on a compressor section of the turbine engine to effect a reduction in power output from the turbine engine.

18. The method of claim 16, wherein the increase in pressure drop between the combustor shell and the combustor corresponds to an increased flow of cooling air from the combustor shell to a hot gas flow directed through a turbine section of the turbine engine to increase a quenching of the hot gas temperature and effect a reduction in power output from the turbine engine.

19. The method of claim 16, wherein the T_PZ lower limit is selected so as to maintain CO production at less than about 10 ppmvd at 15% O₂.
